(19) United States
(12) Patent Application Publication
(10) Pub. No.: US 2026/0133825 A1
(43) Pub. Date: May 14, 2026

(54) MULTI-CORE MICROCONTROLLER PROGRAMMING SYSTEMS AND METHODS

(71) Applicant: OpenMV, LLC, Atlanta, GA (US)

(72) Inventor: Ibrahim ABDALKADER, Helsingborg (SE)

(21) Appl. No.: 18/947,029

(22) Filed: Nov. 14, 2024

(51) Int. Cl. G06F 9/48

(52) U.S. Cl. CPC G06F 9/4881; G06F 9/485

(57) ABSTRACT

Multi-core microcontroller programming systems and methods are provided, including systems, methods and computer program code for executing a program using a multi-core processor.

### BACKGROUND

The use of multi-core microcontrollers is increasing. Often, multi-core microcontrollers (“MCUs”) have a high-performance core and a low-power core (also referred to herein as a “primary core” and a “secondary core”, respectively). The low-power core is generally designed to handle background tasks, sensor data processing or other tasks that do not require the same processing power as the high-performance core. More recently, multi-core MCUs have been introduced which have multiple neural network processing units (“NPUs”) (e.g., one per core). These multi-core MCUs have great potential in a wide range of applications.

Unfortunately, however, it is very difficult for developers to build applications to utilize the low-power core. To fully utilize the features of such multi-core MCUs, it is typically necessary to develop multiple firmware images (one for the primary core and one for the secondary core). These firmware images are required to enable the cores to communicate and synchronize with each other. For example, an end-user must have experience with integrating an Inter-Processor Communications (“IPC”) framework (such as the OpenAMP framework available at www.openampproject.org) into the firmware. This also requires knowledge of the intricate details of the microcontroller's architecture, peripherals, hardware synchronization primitives, software stacks and drivers as well as the compiler toolchain. Further, multi-core MCUs with separate NPUs require experience using the vendor's tools to generate models that are optimized and configured specifically for each NPU. The goal of achieving low-power consumption with the MCU further complicates development, as modern MCUs have multiple power domains which enable control of different peripherals and components. These power domains must be carefully sequenced to avoid system crashes.

It would be desirable to provide programming and control systems and methods which substantially reduce or eliminate the complexity of programming a multi-core MCU. It would further be desirable to provide programming and control systems and methods which enable developers to easily and quickly build and deploy applications that fully utilize features of the secondary core.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1 is a diagram illustrating a multi-core processor implementing features of some embodiments of the present invention.

FIG. 2 is a diagram illustrating portions of a system implementing features of some embodiments.

FIG. 3 is a diagram illustrating a method for initializing a secondary core pursuant to some embodiments.

FIG. 4 is a diagram illustrating a method for executing code on a secondary core pursuant to some embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Embodiments relate to systems, methods and computer program code for executing a program on a secondary core of a multi-core processing system such as an MCU. Embodiments allow the coordination of program execution between a primary core and one or more secondary core(s) of a multi-core processing system without requiring complex and time-consuming firmware coding and configuration.

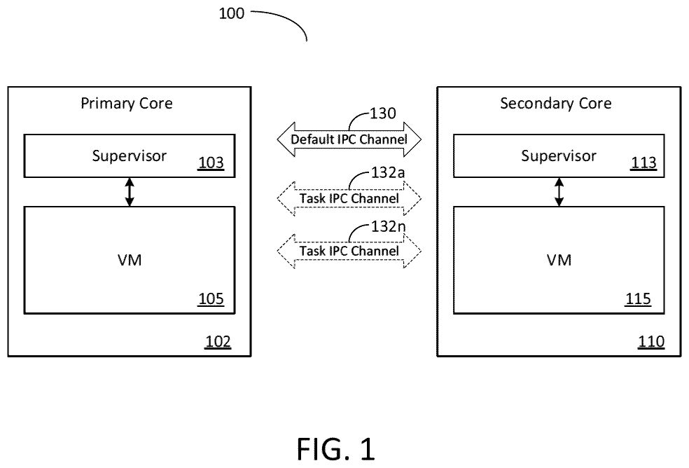

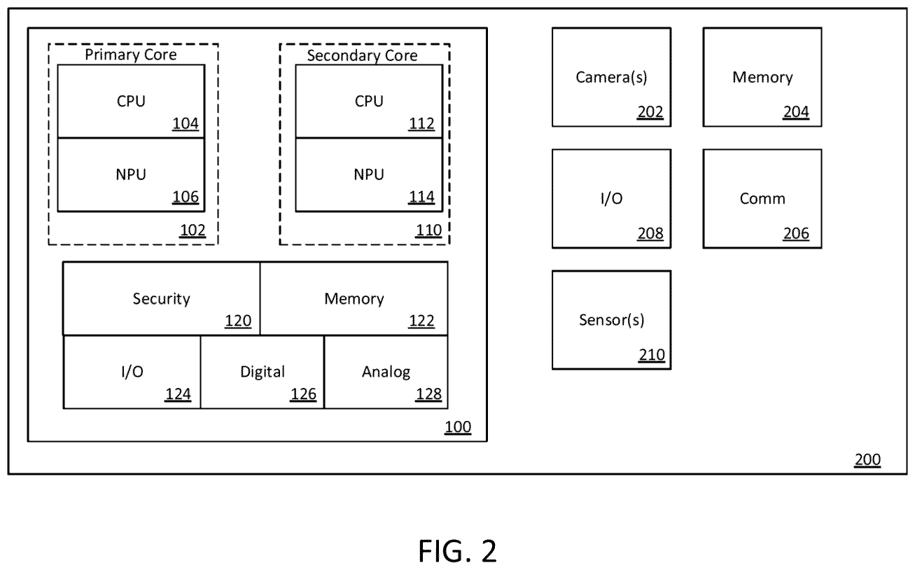

Features of some embodiments will be described by first referring to FIG. 1 which depicts portions of a device 100 configured to operate pursuant to some embodiments. While a number of components are not shown in FIG. 1 (and some of which will be described in conjunction with FIG. 2 and elsewhere herein), the elements shown in FIG. 1 include a primary core 102 and a secondary core 110 of a multi-core MCU. For example, the multi-core MCU may be the STM32H747 from STMicroelectronics N.V., the IMXRT1176 from NXP Semiconductors N.V., or other multi-core MCUs in which one or more secondary core(s) may be configured as a low-power core that sits dormant for most applications.

As shown, the primary core 102 runs a supervisor 103 application and a virtual machine (“VM”) 105. Similarly, the secondary core 110 also runs a supervisor 113 application and a VM 115. Pursuant to some embodiments, the VM 105, 115 is the MicroPython VM with integrated OpenAMP support available from www.micropython.org. In some embodiments, the supervisor 103, 113 may be written in Python.

In some embodiments, the supervisor 113 may be loaded onto the secondary core 110 using a boot loader, while the supervisor 103 may be loaded onto the primary core 102 using a boot loader or from an external drive.

This allows use of a high-level OpenAMP API to allow communication between the cores 102, 110. This API provides processor life cycle management (“LCM”) such as loading firmware as well as starting and resetting the secondary core 110. The use of the MicroPython VM 115 on the secondary core 110 partially solves the problem of developing firmware for the secondary core(s) 110, as it allows an end-user to program the secondary core 110 using Python code rather than developing firmware to program the secondary core 110. It also allows the cores 102, 110 to communicate with each other using high-level abstractions. However, it does not address the issue of delivering the secondary core's 110 Python code, as unlike the primary core 102, the secondary core 110 does not typically have access to a USB or other external device to load from. If the secondary core 110 required code changes, the firmware would require rebuilding.

To solve this technical challenge, embodiments utilize IPC channels to deliver code to run on the secondary core 110. As will be described further herein, the supervisor 103, 113 runs on top of the VM 105, 115 and cause the creation of a default inter-process communication (“IPC”) channel 130 between the primary core 102 and the secondary core 110. For example, when the multi-core processor (which includes the primary core 102 and the secondary core 110) is booted, the supervisor 103, 113 create a default IPC channel 130 for use in communication between the two cores 102, 110. For example, in some embodiments, the secondary core 110 may be booted first and supervisor 113 may perform processing to arrive at a state where it is ready to receive compiled bytecode from the primary core 102 (e.g., by creating the default IPC channel 130). As another example, in some embodiments, the primary core 102 will store the bytecode of the tasks to be executed by the secondary core 110 and hold those tasks until the secondary core 110 is started. In this case, the supervisor 103 will transmit the tasks one by one to the secondary core 110 as soon as the secondary core 110 opens its end of the default IPC channel 130. As will be discussed further below, the default IPC channel 130 is used, pursuant to the present invention, to deliver code to the secondary core 110 for execution by the secondary core 110.

Pursuant to some embodiments, the default IPC channel 130 is used to transmit compiled bytecode from the primary core 102 to the secondary core 110 for execution in the VM 115. For example, to send tasks to the secondary core 110, the primary core 102 sends Python coroutines in the form of compiled Python bytecode to the secondary core 110. The compiled Python bytecode received by the secondary core 110 is executed by the secondary core 110 as an Asyncio task.

Pursuant to some embodiments, to indicate that a function is to be executed on the secondary core 110 as an Asyncio task, a high level API is provided in the form of a Python decorator. The use of a Python decorator causes a decorated block of code to be compiled and stored as bytecode for delivery to the secondary core 110.

When the secondary core 110 is running and ready to execute tasks on its VM 115, the primary core 102 transmits the compiled bytecode to the supervisor 113 of the secondary core 110 over the default IPC channel 130. The supervisor 113 causes the received bytecode to be executed on the VM 115 of the secondary core 110.

The supervisor 103 may be programmed to perform endpoint management (e.g., by providing functions to initialize and manage task IPC channels 132 as will be described further below). The supervisor 103 may perform processing to listen for announcements or messages from the secondary core 110 over the task IPC channels 132. The supervisor 103 may further be programmed to perform processing to listen for service announcements or specific tasks. When a new task IPC channel 132 is created, the supervisor 103 creates a corresponding endpoint on the primary core 102 for handling messages over that channel. The supervisor 103 also defines an “async_remote” decorator to convert functions to MicroPython bytecode for delivery to the secondary core 110 and to register functions decorated by the decorator as tasks.

In some embodiments, the supervisor 113 of the secondary core 110 includes code to perform functions such as task management, the reception of compiled bytecode, execution of asynchronous processing, control of sensors or other devices, and output redirection. For example, the supervisor 113 may include code to running tasks (received as compiled bytecode) as asynchronous tasks. A dictionary, for example, may be used to keep track of active tasks being run by the secondary core 110. If a task raises an exception, in some embodiments, the supervisor 113 will log the error and remove the task. The supervisor 113 may include code to control the operation of sensors or other peripherals or devices in communication with the secondary core 110. For example, in example applications described further below, a microphone or a light emitting diode (“LED”) may be controlled by code included in the supervisor 113. The supervisor 113 may also include code to perform output redirection (e.g., to return the output of a task to the primary core 102 via an associated task IPC channel 132).

For example, the following code is decorated using a decorator “openamp.async_remote” which indicates that the decorated code is to be executed on the secondary core 110. Decoration of a code block run by the primary core 102 will cause the VM 105 of the primary core 102 to compile the decorated code block as bytecode and deliver the decorated code block to the supervisor 113 for execution by the VM 115 of the secondary core.

```
@openamp.async_remote
async def task(ept):
  led=LED(“LED_BLUE”)
  while True:
    led.toggle( )
    ept.send(“Task going to sleep”)
    await asyncio.sleep(0.5)
```

In this illustrative example, the decorator (“@openamp.async_remote”) indicates that a co-routine (“task”) is to be called remotely (via the secondary core 110). The “task” co-routine is asynchronous, allowing it to run in a cooperative scheduling fashion. For example, a running task will block other tasks from running until the task is no longer running. In some embodiments, a co-routine (“task”) will generally include an “asyncio.sleep( )” command to indicate that the co-routine can yield to other tasks. The “task” co-routine takes a parameter (“ept”) that identifies the task IPC channel 132 which is used for communication between VM 105 and VM 115. The “task” co-routine creates an “led” object for a blue LED associated with the MCU (not shown in FIG. 1). The “task” co-routine operates in a while loop that can run continuously on the secondary core 110. The “task” co-routine sends a message to the primary core 102 via the task IPC channel 132 (designated as the “ept”) to indicate that the task is entering a brief pause (the message sent is “Task going to sleep”), and the task is then paused for 0.5 seconds asynchronously, allowing other tasks to run during the wait.

This simple example illustrates how a primary program run on the VM 105 of the primary core 102 can cause code to be executed on the VM 115 of the secondary core 110. Pursuant to some embodiments, when the supervisor 113 creates the task (here, the task associated with toggling the blue LED), the supervisor 113 also creates a dedicated IPC channel for the task (e.g., such as dedicated IPC channel 132). Each task can then send its output to the primary core 102 via this dedicated IPC channel 132. The primary core 102 receives the output over the dedicated IPC channel 132 in a callback function. This allows the primary core 102 to communicate with the secondary core 110 to receive data associated with the execution of the remote task.

A number of tasks can be invoked and be run asynchronously, allowing highly complex functions to be performed by the primary core 102 and the secondary core 110. As shown in FIG. 1, a number of task IPC channels 132a-132n may be created, each providing a communication channel to the primary core 102 of results or information from tasks running asynchronously on the secondary core 110.

While this example only depicts a dual-core processor, multi-core processors can be controlled in a similar manner using features of some embodiments. Embodiments allow an end-user to easily utilize one or more secondary core(s) of a multi-core MCU without writing custom firmware, rebuilding the firmware, or having any knowledge of IPC or the hardware of the MCU. End-users simply write the secondary core's code at runtime by decorating a Python function. Further, power control is automatically handled by the end-user through library API calls and the IPC channels 132 to wakeup the primary core 102 if the primary core 102 goes to sleep while waiting for a response from the secondary core 110.

An illustrative device 200 (e.g., implemented as a system on a chip or “SOC”) which can implement features of the present invention will now be described by reference to FIG. 2. As shown in FIG. 2, the device 200 may include a multi-core MCU 100 including a primary core 102 and a secondary core 110, each of which may have a CPU 104, 112 and an NPU 106, 114 and which are supported by security 120, memory 122, I/O 124, digital interfaces 126 and analog interfaces 128. Security 120 may include hardware based security measures (e.g. with a unique device identifier) as well as secure key generation and storage capabilities. Memory 122 may include on-chip application memory (including volatile and non-volatile memory) used, for example, to store code such as the supervisor 103, 113 and VM 105, 115, etc. I/O 124 may include general input and output interfaces. Digital interfaces 126 may include camera or other digital interfaces, and analog interfaces 128 may include one or more analog to digital converters (“ADCs”), digital to analog converters (“DACs”) or the like to allow the transmission and receipt of analog data. The device 200 may include one or more peripherals such as, for example, one or more cameras 202, memory 204, external I/O 208, communications 206 and sensors 210. For example, the sensors 210 may include temperature sensors, microphones, accelerometers, etc. The external I/O 208 may include a WiFi or Bluetooth low energy radio, one or more input buttons or devices, LEDs or other output devices, etc. Communications 206 may include one or more communications devices allowing communications between the device 200 and external devices or systems (e.g., such as a USB highspeed port, etc.). Memory 204 may include a file system for onboard storage, etc. Cameras 202 may include one or more cameras such as a color global shutter camera, etc. Embodiments allow end-users to easily program such a device 200 without requiring the user to write custom firmware, rebuild the firmware, or have any knowledge of IPC or the hardware of the MCU. Those skilled in the art, upon reading the present disclosure, will appreciate that the device 200 of FIG. 2 is an illustrative example, and that other implementations of multi-core MCU's may be provided on other devices.

An example of an application that may be run on device 200 is an audio keyword recognition application that causes the low-power secondary core 110 to “listen” for keywords. Once it hears a keyword, the secondary core 110 notifies the primary core 102 which then wakes up from a low-power mode to perform processing (e.g., such as facial recognition or other processing requiring a more performant processor). Embodiments allow such applications to easily be created by end-users without requiring the end-user to perform complex and time-consuming firmware coding and configuration. To implement such an application, the following Python code may be executed on the VM 105 of the primary core 102.

```
import ml
import openamp
import sensor
@openamp.async_remote
async def task1(ept):
  import time
  from ml.apps import MicroSpeech
  speech=MicroSpeech(labels=[“Wakeup”])
  while True:
    labels=speech.listen(threshold=0.70, timeout=0)
    if labels[0] is not None:
      openamp.notify( ) #notify the main core
#start the secondary core
rproc=openamp.RemoteProc(0x804200000)
rproc.start( )
model=ml.Model(“face_detection_model”)
while True:
  #enter low power stop mode
  machine.sleep( )
  #woken up on IRQ from the secondary core. Perform face detection
  img=sensor.snapshot( )
  output=model.predict([img], callback=yolo_post_process)
  #process the results then go back to sleep
```

This code operates as follows. First, the program is executed on the VM 105 of the primary core 102. The decorator (“@openamp.async_remote”) signals that the decorated code block is to be compiled into bytecode and transmitted to the secondary core 110 for execution on the VM 115. Upon receipt of the compiled bytecode, the supervisor 113 of the secondary core 110 creates a task IPC channel 132 for the task (“task1”), and task1 is executed as an asynchronous remote function or co-routine. Rproc.start( ) starts the secondary core 110 allowing it to run the task1 co-routine. In the example, the address “0x80420000” is the address of the firmware of the secondary core 110, and in the example, the primary core 102 is currently powered up and running the program. It boots the secondary core 110 from the firmware address. In some embodiments, rather than booting from an address, the secondary core 110 may be booted from a firmware image stored on the filesystem (e.g., using a command such as rproc=openamp.RemoteProc(“path/to/firmware.elf”).

Inside “task1”, a speech recognition model (in the example, the model is the “MicorSpeech” model) is loaded from ml.apps and is configured to recognize a keyword (“wakeup”) with a 0.7 confidence threshold. This co-routine (“task1”) runs in an infinite loop where it continuously listens for the wakeup word using speech.listen( ) If an input is recognized with sufficient confidence, openamp.notify( ) is called (using the “task1” task IPC channel 132) to notify the primary core 102.

While the “task1” co-routine is running on the secondary core 110, the primary core 102 sets up a machine learning model (the face_detection_model) and enters a loop where it enters a low-power mode using machine.sleep( ) This allows the primary core 102 to conserve energy until it is woken up by an interrupt from the secondary core 110 (triggered by openamp.notify( )). After waking up, the primary core 102 captures an image from a sensor using sensor.snapshot( ) (e.g., by operating camera 202 of FIG. 2). The captured image (“img”) is processed using the face detection model by invoking model.predict( ) and a callback function yolo_post_process for processing the output. The result is an easily configured application which takes advantage of the high-performance processing of the primary core 102 only when needed-when the low-power secondary core 110 detects a wakeup word. Further, the secondary core 110 handles the task of continuous listening for a wake word in an asynchronous manner such that it doesn't block other operations of the primary core 102.

A number of other asynchronous tasks can be performed by the secondary core 110 in this manner, each of which may communicate with the primary core 102 via a task IPC channel 132.

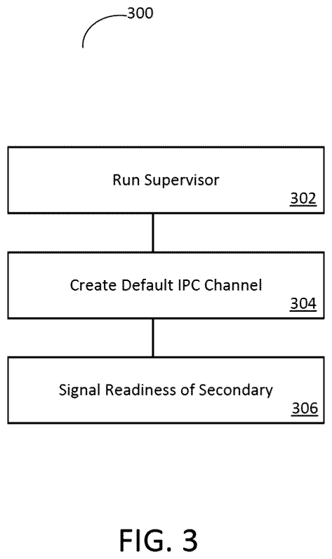

Reference is now made to FIG. 3 which depicts a process 300 that may be performed by the device 200 to initialize a secondary core 110 according to some embodiments. The process 300 may be executed each time the device 200 is rebooted or powered. The process 300 begins with processing to run the supervisor (shown as 113 of FIG. 1) which may be stored in a memory such as memory 122. Running the supervisor may cause the creation of a default IPC channel (such as the channel 130 of FIG. 1) allowing communication between the primary core 102 and the secondary core 110. Once the default IPC channel 130 is created, processing continues at 306 where the secondary core 110 signals that it is ready to receive compiled bytecode over the default IPC channel 130. In some embodiments, this may be signaled by transmitting a ready signal over the default IPC channel 130. In some embodiments, the creation of the default IPC channel 130 automatically signals readiness of the secondary core 110 to receive compiled bytecode. The secondary core 110 is now ready to receive an execute compiled bytecode transmitted to the secondary core 110 from the primary core 102. As discussed above, in some embodiments, the primary core 102 may start first and may hold or queue tasks until the secondary core 110 is ready and able to receive compiled bytecode for execution.

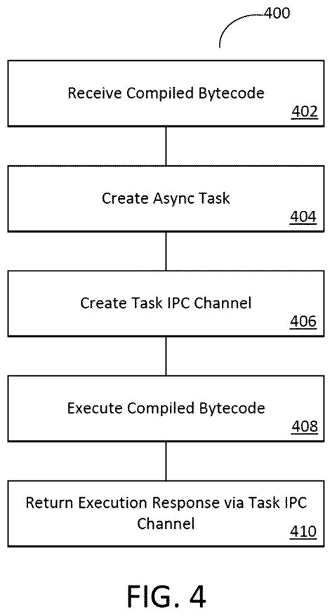

Reference is now made to FIG. 4 which depicts a process 400 that may be performed by the secondary core 110 after processing of FIG. 3. The process 400 may be performed multiple times, for multiple different tasks. Process 400 begins at 402 with receipt by the secondary core 110 of compiled bytecode from the primary core 102. For example, in the face detection example provided above, the bytecode is received when the primary core 102 executes a program (e.g., in the VM 105) that includes a decorated function. The decorated function is compiled into bytecode and delivered to the secondary core 110 at 402.

Processing continues at 404 where the secondary core 110 creates an asynchronous task using the compiled bytecode. For example, in the face detection example provided above, the asynchronous task is “task1”. The supervisor 113 and the VM 115 also create a task IPC channel 132 and communicate the details of the task IPC channel 132 to the primary core 102. This task IPC channel 132 is dedicated to the communication of results and information associated with the execution of the task by the secondary core 110. Processing continues at 408 where the secondary core 110 executes the compiled bytecode (e.g., in the VM 115). This processing may be a short or long running process. Processing continues at 410 where the secondary core 110 returns any execution response to the primary core 102 via the task IPC channel 132 created in step 406. This task IPC channel 132 may be torn down or terminated if the execution is complete, or it may remain open if further execution responses may be expected from the execution of the task.

The result is the ability for an end-user to easily program a multi-core MCU to take advantage of features offered by a low-power core or multiple NPUs without developing multiple firmware images or performing other complex programming requiring knowledge of the MCU's architecture, peripherals, hardware synchronization primitives, software stacks and drivers as well as the compiler toolchain. By allowing compiled bytecode to be transmitted to, and executed by, one or more secondary cores 110, end-users may easily develop complex programs. Further, by using the MicroPython API and other device compatible APIs (such as APIs to control general purpose I/O pins of the MCU) end-users do not need to perform complex programming tasks to interact with peripheral devices such as LEDs, cameras or the like.

Embodiments are particularly suited for use in executing programs that require a high-performance processor to execute machine learning or other compute-intensive applications (such as the face detection example described above) as well as detection applications (such as the wakeup examples described above). Embodiments allow the long running detection application to be performed by a low-power secondary core 110 while the compute-intensive machine learning application may be performed by the high-performance primary core 102. The result is operation of a multi-core processor that has improved power consumption while still achieving high performance.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A method, comprising:
executing a program on a primary core of a multi-core processor;
identifying a component of the program that is to be run on a secondary core of the multi-core processor, the component identified using a decorator;
compiling, by the primary core, the component into bytecode;
transmitting the compiled bytecode to the secondary core over a default communication channel as a first task;
executing, by the secondary core, the first task; and
transmitting, from the secondary core to the primary core, at least a first result of the execution of the first task over a task communication channel established by the secondary core for the first task.

2. The method of claim 1, wherein executing the program on the primary core includes executing the program in a primary core virtual machine.

3. The method of claim 1, wherein executing the first task by the secondary core includes executing the compiled bytecode in a secondary core virtual machine.

4. The method of claim 1, wherein the default communication channel is a default Inter-Processor Communications (“IPC”) channel.

5. The method of claim 4, wherein the task communication channel is an IPC channel established by a supervisor program of the secondary core associated with the first task.

6. The method of claim 4, wherein the default IPC channel is established between a supervisor program of the primary core and a supervisor program of the secondary core when the secondary core is booted and in a ready state.

7. The method of claim 1, further comprising:
identifying a second component of the program that is to be run on a secondary core of the multi-core processor, the second component identified using a decorator;
compiling, by the primary core, the second component into second bytecode;
transmitting the compiled second bytecode to the secondary core over a default communication channel as a second task;
executing, by the secondary core, the second task; and
transmitting, from the secondary core to the primary core, at least a first result of the execution of the second task over a second task communication channel established by the secondary core for the second task.

8. The method of claim 7, wherein the first task and the second task are executed by the secondary core asynchronously.

9. The method of claim 8, wherein the first task and the second task each include program code to yield processing to another task.

10. The method of claim 1, wherein the primary core is a high performance core and the secondary core is a low power core.

11. The method of claim 10, wherein the program includes execution of a machine learning model initiated by detection of sensor data.

12. The method of claim 11, wherein the machine learning model is executed by the primary core and wherein the sensor data is detected by the secondary core.

13. The method of claim 12, wherein the machine learning model is an image recognition model.

14. The method of claim 13, wherein the sensor data is audio data received from a microphone in communication with the multi-core processor.

15. A non-transitory computer-readable medium comprising instructions which when executed by a computer cause one of a primary core processor and a secondary core processor of a multi-core processor to perform a method comprising:
executing a program on a primary core of a multi-core processor;
identifying a component of the program that is to be run on a secondary core of the multi-core processor, the component identified using a decorator;
compiling, by the primary core, the component into bytecode;
transmitting the compiled bytecode to the secondary core over a default communication channel as a first task;
executing, by the secondary core, the first task; and
transmitting, from the secondary core to the primary core, at least a first result of the execution of the first task over a task communication channel established by the secondary core for the first task.

16. The non-transitory computer-readable medium of claim 15, wherein the method further comprises:
identifying a second component of the program that is to be run on a secondary core of the multi-core processor, the second component identified using a decorator;
compiling, by the primary core, the second component into second bytecode;
transmitting the compiled second bytecode to the secondary core over a default communication channel as a second task;
executing, by the secondary core, the second task; and
transmitting, from the secondary core to the primary core, at least a first result of the execution of the second task over a second task communication channel established by the secondary core for the second task.

17. The non-transitory computer-readable medium of claim 16, wherein the first task and the second task are executed by the secondary core asynchronously.

18. The non-transitory computer-readable medium of claim 15, wherein the task communication channel is an IPC channel established by a supervisor program of the secondary core associated with the first task.

19. A multi-core computing device, comprising:
a data store configured to store a program; and
a first processor configured to
execute the program;
identify a component of the program that is to be run on a second processor of the multi-core computing device;
compile the component into bytecode;
transmit the compiled bytecode to the second processor over a default communication channel as a first task;
receive, from the second processor over a task communication channel established by the second processor for the first task, at least a first result of the execution of the first task;
perform processing based on the at least first result.

20. The multi-core computing device of claim 19, wherein the first processor is a high performance processor, and the second processor is a low-power processor.
